(19) United States
(12) Patent Application Publication
(10) Pub. No.: US 2009/0315277 A1
(43) Pub. Date: Dec. 24, 2009

(54) Rubber seal for semi-dynamic and dynamic applications

(76) Inventors: Kaori Iwamoto, Tochigi (JP); Bunichi Rai, Tokyo (JP)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/214,837

(22) Filed: Jun. 23, 2008

(51) Int. Cl. F16J 15/16

(52) U.S. Cl. 277/641

(57) ABSTRACT

A resilient seal element for use in an annular groove of dovetail configuration comprising, in cross section, a base and two sidewalls of equal length being connected by a convex arc.

### BACKGROUND OF THE INVENTION

The present invention relates to a rubber seal element designed for semi-dynamic and/or dynamic applications that utilize a dovetail shaped groove configuration.

O-rings made from natural or synthetic rubber are well known for use as sealing devices in annular grooves positioned between two mating surfaces for containing various fluids. Seals for corrosive fluids and strong solvents, or for high temperature applications, often require the rubber to be a fluoroelastomer or perfluoroelastomer.

In semi-dynamic and dynamic applications, wherein one of the mating surfaces in contact with the O-ring can move, such movement can cause the O-ring to shift and/or twist in its seat, i.e., in the groove in which the O-ring is mounted. Shifting and/or twisting can physically damage or even break the O-ring and cause leaks. Historically, this problem has been addressed by designing the seat to have a dovetail shaped cross-section, which more firmly holds the O-ring in place. However, installing an O-ring seal into a dove-tail shaped groove without damaging or twisting the seal can be difficult. A seal which is damaged or twisted in its seat during installation can fail immediately, or it may have a substantially shortened useful lifetime. Accordingly, it would be advantageous to have a rubber seal element which is convenient and easy to install into a dovetail shaped seat and which, when installed, provides excellent semi-dynamic and dynamic sealing properties.

### SUMMARY OF THE INVENTION

The present invention according to one embodiment is a resilient seal for installation into an annular groove wherein in cross-section the seal comprises a base having a length W4 with opposed side walls of equal length. Each sidewall is defined by a line extending from a point of intersection located below the base to an end point above the base, and the sidewalls have an included angle α which can range from 95° to 125°. An arc connects each end point to form a convex surface in relation to the base.

The resilient seal of the invention is particularly well suited for use where the annular groove is of dovetail configuration. The groove comprises a mouth having a width W1. Depending from the mouth are two sidewalls of generally equal length that extend away from each other. A base wall connects the two sidewalls thereby forming the dovetail configuration.

The base of the resilient seal is generally flat, and its length W4 is smaller than the width W1 of the mouth of the dovetail groove. The distance W3 between the end point of each sidewall is greater than the width W1 of the mouth of the annular groove.

The rubber seal element according to the invention is convenient and easy to install into a dovetail shaped seat and provides excellent semi-dynamic and dynamic sealing properties over an extended useful life.

### BRIEF DESCRIPTION OF THE DRAWINGS

FIG. 1 is a cross-sectional view of a seal element according to the invention.

FIG. 2 is a cross-sectional view of a seal element according to the invention shown in overlapping relation to an outline of a dovetail shaped groove of related dimensions.

### DETAILED DESCRIPTION OF THE INVENTION

The present invention is an easy to install generally annular rubber seal element useful for dynamic and semi-dynamic sealing applications which utilize a seal seat having a dovetail shaped groove configuration. By “generally annular” it is meant that the seal element of this invention need not be a circular ring, but may include, for example, square or rectangular rings. Specific applications for the seals of the invention include, for example, slit valve doors and gate valves.

The seal element of the invention can be made from natural or synthetic rubbers and is generally annularly shaped. Fluoroelastomers and perfluoroelastomers are preferred rubbers for seals to be deployed in corrosive or high temperature environments. Perfluoroelastomers are especially preferred in high temperature, corrosive chemical and plasma environments, such as, for example, those found in semi-conductor manufacture. However, other natural or synthetic rubbers can be used in practicing the invention with satisfactory results depending on the resistance of the rubber to the fluid to be sealed and the temperature of the environment in which the seal is to be employed.

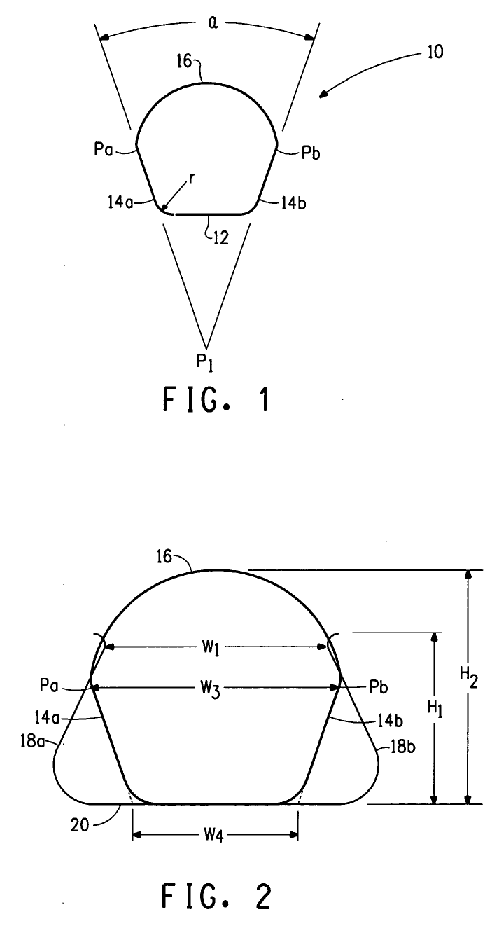

Referring now to the drawings, FIG. 1 is a cross-sectional view of a seal element 10 according to the invention. The seal has a base 12 having a length W4 (shown in FIG. 2) and opposed sidewalls 14a and 14b of equal length. Each opposed sidewall 14a and 14b is defined by a line extending from a point of intersection P1 below base 12 to an end point Pa and Pb, respectively. The sidewalls 14a and 14b have an included angle α which can range from 95° to 125°. End points Pa and Pb are connected by an arc 16 which defines a convex surface as shown.

Resilient seal element 10 of the invention is designed for use in an annular groove of dovetail configuration. FIG. 2 shows seal element 10 according to the invention in overlapping relation to an outline of a dovetail shaped groove of related or corresponding dimensions. One skilled in the art will readily recognize that the overall size of sealing element 10 of the present invention will be determined by the size and shape of the dovetail groove in which the seal is to be positioned.

The dovetail configuration contemplated according to the invention comprises a mouth having a width W1. Two sidewalls 18a and 18b depend from the mouth and extend away from each other as shown. A generally flat base 20 connects each of the sidewalls 18a and 18b to thereby form the dovetail configuration.

As can be seen in FIGS. 1 and 2, base 12 of resilient seal 10 is generally flat, and the corners which define the intersection or connection of the base with sidewalls 14a and 14b have been rounded. Any convenient radius “r” can be used.

As can be seen in FIG. 2, the length W4 of the base is smaller than the width W1 of the dovetail groove. Furthermore, the width W3 between end points Pa and Pb of each sidewall is greater than the width W1 of the mouth of the dovetail groove. In a preferred embodiment of the invention, W4 has a length dimension equal to the value of W1×(0.55 to 0.75), and W3 has a length dimension equal to the value of W1×(1.12 to 1.15). In practice and for best sealing performance, the height H2 of seal 10 will have a value that is equal to the depth of the dovetail groove H1×(1.15 to 1.35).

From the foregoing description, it can be seen that the present invention comprises a resilient seal element for installation in an annual groove having a dovetail configuration. It will be recognized by those skilled in the art that changes may be made to the above-described embodiment of the invention without departing from the broad inventive concepts thereof. It is understood, therefore, that this invention is not to be limited to the particular embodiment disclosed, but is intended to cover all modifications which are within the spirit and scope of the appended claims.

1. A resilient seal for installation into an annular groove wherein in cross-section the seal comprises:
(a) a base having a length W4;
(b) opposed side walls of equal length, each sidewall being defined by a line extending from a point of intersection below the base to an end point above the base and having an included angle α of from 95° to 125°; and
(c) an arc having a convex surface connecting each end point.

2. The resilient seal as defined in claim 1 wherein the annular groove is of dovetail configuration comprising a mouth having a width W1, two sidewalls depending from the mouth that extend away from each other and a base wall that is connected to the two sidewalls thereby forming the dovetail configuration.

3. The resilient seal as defined in claim 2 wherein (i) the base is flat and its length W4 is smaller than the width W1 of the mouth of the dovetail groove, and (ii) the distance W3 between the end point of each sidewall is greater than the width W1 of the mouth of the dovetail groove.

4. The resilient seal as defined in claim 3 wherein W4 has a length equal to the value of W1×(0.55 to 0.75), and W3 has a length equal to the value of W1×(1.12 to 1.15).
